(19) United States
(12) Patent Application Publication
(10) Pub. No.: US 2010/0106739 A1
(43) Pub. Date: Apr. 29, 2010

(54) AUTHENTICATED DATABASE SYSTEM

(75) Inventor: Knut Petter Daehlin Lehre, Oslo (NO)

Correspondence Address: BIRCH STEWART KOLASCH & BIRCH, PO BOX 747, FALLS CHURCH, VA, 22040-0747, US

(73) Assignee: Science Linker AS, Oslo (NO)

(21) Appl. No.: 12/531,910

(22) PCT Filed: Mar. 12, 2008
(86) PCT No.: PCT/NO2008/000090

§ 371 Date: Oct. 13, 2009

(30) Foreign Application Priority Data
Mar. 19, 2007 (NO) 2007 1475

(51) Int. Cl. G06F 17/30

(52) U.S. Cl. 707/769; 707/803; 707/E17.044; 707/E17.032; 707/797; 707/E17.05

(57) ABSTRACT

This invention is a generically constructed and authenticated relational database, the main aim of which is to manage data, records and logistics information and the tracing of said data and typically applied to a variety of workflow processes in e.g., but not restricted to, science and industry. To this end information is entered through notebooks or through instruments into a database that can be either a single user system or a full system. A single user system has limited functionality and can be connected to only a single full system at a time, whereas a full system is able to communicate with a plurality of single user systems, databases and other full systems according to the present innovation. This system authenticates data and can be used for reverse tracing to for instance lab animals in biomedical research, and forward tracing to for instance the retail part of the food value chain from the animal of origin or from ingredients like feed or other components added to the chain. Central is the generic architecture of the system, allowing creation and linking into the existing data categories new data categories and data tables without the need to modify the system or the computer program.

### FIELD OF THE INVENTION

Present invention is related to a traceable information system, more specific to a generic authenticated information system for use within research, industry, food production and the like.

### BACKGROUND OF THE INVENTION

Within industry, food production, research and the like, it is necessary to document the work carried out. This is traditionally done by manual notebooks in paper form. However, in recent years computer programs have been developed to replace these traditional notebooks with electronic notebooks. Although many of these programs are good, they are typically tailor made to fit specific needs described by the customers. There is no system that both address all of the problems listed below at the same time and which is also designed to form a standard capable of evolving by a distributed user driven bottom-up approach to meet future demands.

Both the problems caused by inadequate notebooks and the difficulties of making them adequate are increasing. This is due to the seemingly exponential growth of the complexity caused by new methodology, new types of instruments, types or combinations of genetic alterations of organism, legal regulations, intellectual property rights and so on. The problems that need to be solved comprise the following:

1. The traditional laboratory notebook is based on paper, and the researchers write by hand and attach pictures, printouts, diagrams and typed pieces of text. These notebooks are not searchable; they are time consuming to write well enough to be complete and unambiguous; they are often used as workbooks and amended making authentication difficult. Further, they are typically too time consuming to back up because they have to be manually photocopied or scanned due to their mixed content.

2. The traditional notebooks do not work well with electronic data files as these have to be stored on a different medium. As the primary collection of data is increasingly becoming electronic, the aforementioned problem is becoming more serious as the original recordings such as digital images and listings, represent the original data which is required by law to archive safely. Electronic documents are typically generated on a variety of different types of equipment which may be attached to different computers. The result is that original files are partly stored on the computers on which they were first produced, partly on network servers, partly on the workers own PCs and partly on other storage units. This implies that files can easily get lost, and that it may be difficult to certify that a particular file is the original file and not a modified one. Both authentication and backup are thereby difficult.

3. A related problem is unequivocal labeling. This problem does not only comprise electronic files, but all materials including physical samples and items, that cannot be glued into a traditional notebook. While organizations with strict routines typically have systems in place to avoid this problem such as hospital associated laboratories performing standard analysis on samples obtained from patients, other organizations with constantly changing activities, like basic research laboratories, have difficulties keeping up because the activities often change faster than their management systems.

4. Different people tend to organize their notebooks differently according to their personality, to their skills and to other factors. As a consequence it is hard to fully understand notebooks written by others, and this makes information sharing inefficient and unreliable as misunderstandings easily occur. Fragmented or incomplete recording as described above will of course aggravate this further. Another consequence of this is that most of the information generated during a research project is lost because only a tiny fraction of it can fit into scientific article. Scientific journals have realized this and are starting to demand database deposition of raw data both to reduce the loss of information and to facilitate later verification. This, however, increases the burden on researchers because their records are typically fragmented and non-standardized as described above.

In most electronic laboratory notebooks the relationships between different data categories are predefined. This means that the database architecture is often difficult to modify when new data categories arise or when the workflow and data generation process change. This is so because links between data are typically of the type which is referred to below as Reference-links or R-links. These links are restricted because a data field in one data table can only carry information from a predefined field in a record in a single and different predefined data table.

There are other systems where links between data can be formed freely. One well known example is the free encyclopedia called Wikipedia. A problem with this system is that the freedom is too great and that searches backwards along the link chain often end up in circular loops. Further, record ownership, access control, and authentication of data, attached files in particular, are difficult.

The main objectives with the present invention are to circumvent the problems with existing systems, to provide a system which will establish a distributed network of independent databases that are locally controlled. Each database has the flexibility to evolve with its license owner, which is hereafter referred to as system administrator or “Superuser” in such a way that it covers all storage needs of the Superuser and at the same time provides a standard enabling the records to be understood by others. The Superuser gets a complete virtual workbench where all activities (both personal and professional) can be stored and integrated with internet searches and e-mail. This is achieved with the generic authenticated information system according to the present invention as it is defined in the claims.

### The Present Invention

The present invention (“the System”) is designed to store each step of a complex workflow as separate information units recorded by the actors who perform each step. By referring to the unique identification numbers of the records representing each information unit, any record can be linked directionally to any other record by referring to the identification number of the record to link from and the identification number of the record to link to. Each record is authenticated by user identification and time stamp. Information units representing the same type of work operation are stored together as records in a data table. The system is modular and high flexible: New data tables can be added to accommodate new operations or data categories, and the records in the new data tables can be linked to any record already present in the system, whether it is present in the same data table, a different data table, or in a different database. Superuser easily adds new data categories and determines how they link to the existing ones without help from the software producer, and without altering neither previously recorded data nor the links between them. The System has views and user interfaces that are generic so that they work without modifications on any new data category that Superuser might want to add. Further, the System has multiple tools that enable users to enter and edit both the data records and the links between them in a single operation.

### BRIEF DESCRIPTION OF THE DRAWINGS

Present invention will be described in more detail in the following with reference to the drawings, where

FIG. 1 shows a schematic overview of the work flow in a typical research group;

FIG. 2 illustrates both how the work flow is broken down into the individual work units performed by one person in one operation and how this information is recorded and linked together using three different types of links, i.e. FB, R, A;

FIG. 3 illustrates the relationship between data tables, records and fields as well as the FB-link table;

FIG. 4 illustrates how one starting material typically gives rise to a number of other materials, resulting in a link-chain with diverging and converging ramifications, a link-tree, and that this can be made within at network of distributed independently controlled databases;

FIG. 5 illustrates how a research group operating database R1 may collect information from public databases and from core facilities, both directly and via material obtained from a collaborator;

FIG. 6 illustrates the formation of a distributed system of locally controlled databases and examples of different versions of the system; and

FIG. 7 shows how a user may collect his or her research history.

### DETAILED DESCRIPTION OF THE PREFERRED EMBODIMENT

To illustrate functionality of the present invention, “the System”, examples are mostly taken from research and food industry, but the System is generic and can be used in many different fields—in fact one of the main aims is to provide a global data exchange and tracking system.

The System can be implemented using different software technologies and the following description represents an example showing how this can be done using a relational database management system, hereafter called “RDBMS”, such as Oracle, Microsoft SQL server, PostgreSQL, MySQL, etc. For instance, one way of storing link information in RDBMS is to use a dedicated data table, but there are alternative means of achieving the same purpose.

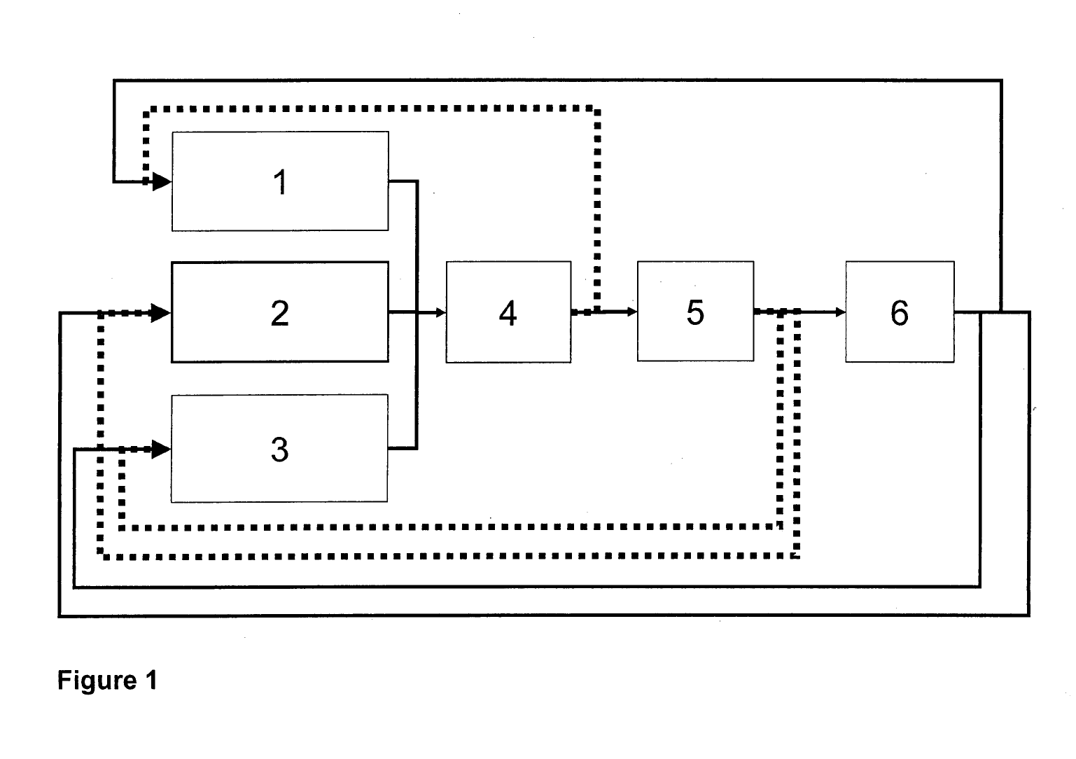

FIG. 1 represents a schematic overview of the work flow in a typical research group. The starting point for research activity is available materials 1, for example biological samples, chemicals, animals etc, existing information 2, e.g. information previously published, previously generated or downloaded from other databases, and ideas and hypotheses 3. Experiments are performed to test the hypotheses leading to the generation of new data and new materials 4 which are subsequently analyzed 5. This leads to new knowledge which is ultimately published 6. The new information and materials produced 4, 5 and 6 initiate new activity as indicated by arrows and dotted lines pointing back to the starting points 1-3. The System is designed to follow this work flow, and at the same time, enable the leader of the research group to monitor the overall process with regard to personnel and money.

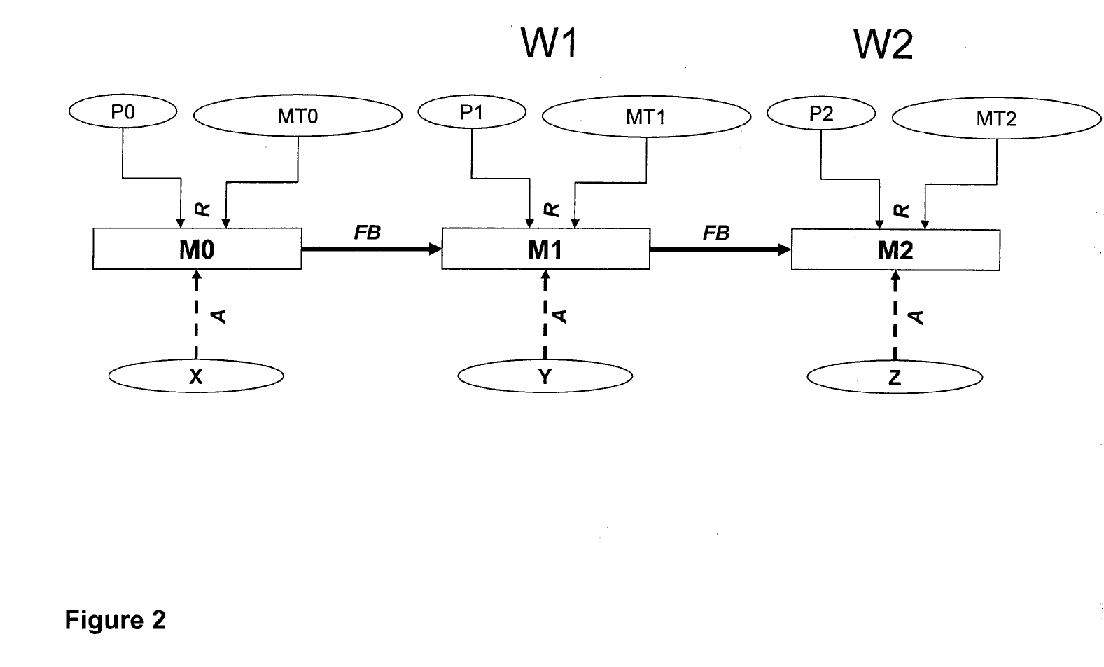

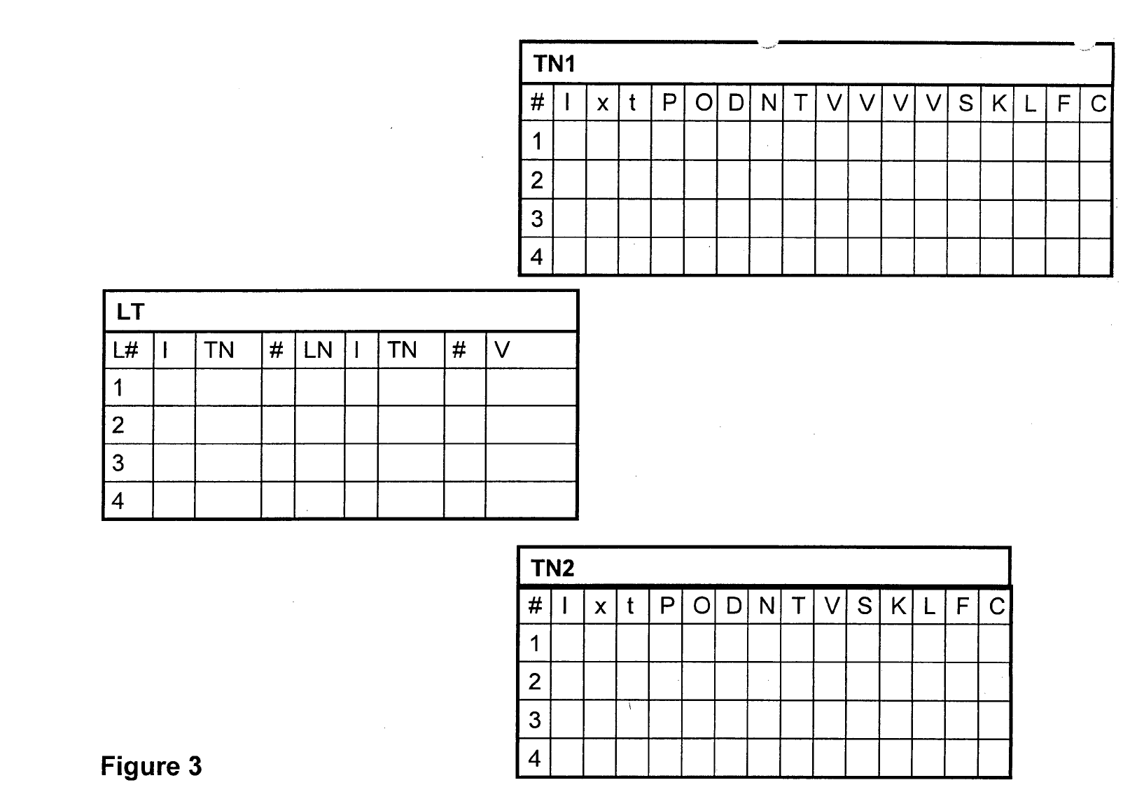

FIG. 2 illustrates that the work flow is broken down into the basic work units which individual actors, e.g. operator, student, technician, researcher, accountant, secretary, administrator, are responsible for, and which they perform in one operation or work unit W1 and W2. Thus, a key principle is to follow how materials whether physical items or virtual items like information, e-mails, ideas or data lead to generation of new materials. This is done by recording each material M0, M1, M2 as separate data records and link the records together so that a forward-backward link chain is formed. In contrast, the records describing the actors P0, P1, P2, tools, or processes involved are attached to this link chain without being part of the link chain itself. Thus there are three types of links FB, R, A: FB: Forward-backward links, hereafter referred to as “FB-links”, which are indicated in FIGS. 1, 2 and 4 by horizontal arrows pointing in forward direction connecting records into what is hereafter referred to as the “FB-link chain”. The FB-links are based on the unique identification numbers of the data records, see FIG. 3 below. By storing the identification number of a record to be linked from and the identification number of record to be linked to, it is possible to link any record in any table, see Regular data tables below, to any number of other records in any other data table, thus, within the same table, between tables and even between different databases as each database has a unique license number. This means complete freedom to make links. However, some limitation is usually desired and Superuser can restricts user freedom, see Configuration tables below. By defining which data tables users are allowed to create links between, Superuser sets the database link policy which is displayed graphically as a link direction diagram, or link map. R: Reference-links, hereafter referred to as “R-links”, attach records comprising information about the records in the FB-link chain. Examples are which actor or database user owns a record, and which project a record belongs to. The R-links are more restricted than the FB-links in that a field in one data table can only carry information from a predefined field in a record in a single and different predefined data table. For example, the owner of a record can only be specified by creating an R-link to a record in the owners table, and not to any other table. Connecting existing information from another table helps standardizing information, reduces data redundancy, and can speed up entering of data. The R-links implement what is known as “normalization” in database theory. A: Links attaching files X, Y, Z to one or multiple records, hereafter referred to as “A-links”.

The names of the actors themselves become automatically R-linked to the record they enter and this attachment signifies record ownership. Any other information may be attached to the record either as R-links to other reference tables or as attached file or files further documenting and describing the work done. The R-links and A-links enable far more data to be recorded than individual actors are likely to be motivated to type into the database as free text. Thus, data regarded as irrelevant at the time of entry may still be recorded. The system of attached files allows for instance laboratory notes that have been written in the traditional way, to be stored in the system. This has the additional advantage of strengthening the documentation of authenticity. Finally, this allows storage of files generated by other software. When for instance MS-Word files or pdf-files are attached to a record, then the System may use MS-Word or Adobe Acrobat to open the file. The same applies to in principle any file type and external program.

This way of recording can be used whenever one operation leads to another along a time axis, and also for hierarchical organization of information like for instance taxonomic organization of life forms. The System can therefore be used in many different fields. One practical example from the field of biomedical research illustrates this in FIG. 2: One researcher P0 obtains an animal M0. Information about the animal is found both in reference table MT0 and in the attached file X. The same or another researcher P1 collects a blood sample from this animal, describes his/her own work in the database by inserting a new record M1 which is FB-linked to the one describing the animal M0 from which the sample was collected and stores the blood sample in a freezer. The sample becomes labeled with the unique database ID-number comprising database license number, table name and record number within table as described above. The name of the researcher himself becomes automatically R-linked to the record he or she has entered. The records comprise several fields, see FIG. 3, including the free text fields “Keywords” and “Notes” where any text can be entered to allow flexibility. To enforce standardization, one of several possible “Material types”, e.g. blood, meat, liver, etc, is selected from a reference table, and that information becomes R-linked to the record. Any other information, e.g. a picture, a scanned copy of a handwritten note or of the label of the animal cage, may be attached to the record as attached files Y by means of A-links further documenting and describing the work done. Later the same or another researcher P2 takes that uniquely tagged sample, extracts something from it thereby generating something new M2 and describes this in the database by inserting new record or records FB-linked to the one created by the previous operator.

By using search functions the FB-link chain can be followed both in backward and in forward direction. Although the records in the table comprising the names of the researchers are normally only connected via R-links to the FB-link chain describing the experimental work flow, they may be part of for instance the FB-link chain describing how research funding is spent, as employment of a person leads to payment of salary, or if the blood of a researcher is used in a research project. Further a person may travel to meetings, make presentations at these meetings and afterwards submit claims of travel reimbursements. Thus, the system allows any number of different FB-link chains to be created in the database. It is sometimes useful to add extra information about the FB-links. For example, if one sample has been used in two different experiments it follows that there are two FB-links from the sample record; one to each the experiments. If 90% of a sample was used in one of experiments and the remaining 10% in the other, then this information can be recorded in the link notes, see FIG. 3.

FIG. 3 illustrates schematically the relationship between data tables, records and fields as well as how the FB-link information, also see FIG. 2, is stored. Different categories of data are stored in different data tables, and the system can hold an unlimited number of tables, the figure only shows three: LT, TN1 and TN2. Each data table has a unique name, name or number or both, and can hold an unlimited number of records indicated in the figure as rows 1-4. Each record is subdivided into data fields illustrated as columns, and records in the same data table have the same fields. The system comprises several different classes of data tables:

Regular data tables TN1 and TN2 are the tables which ordinary database users can see and where they record the information they want to store. To secure user friendliness, these tables are organized so that they operate according to the same set of rules. Each table has a descriptive name and is used to store information that requires the same type of fields. For instance, a table listing journal articles may for instance be called “Bibliography” and comprises fields relevant for appropriate listing of journal articles like for example journal name, authors, page numbers and so on, while a table listing cell cultures may be called “Cell culture” and comprises fields for this like for instance temperature and type of cell culture medium. Thus, some fields differ, both in number and field names, between tables and are schematically indicated in the FIG. 3 as variable fields V. Some fields, however, are present in all regular data tables in order to make the System truly generic. These are fields controlling user access, link information and record authenticity as well as fields to make it possible to utilize generic data visualization tools to display information. Fields present in all regular data tables may comprise: record number #, database license number I, mark x, data subtype t, project P, owner O, date D, number N, title or name T, keywords K, fields S for notes and descriptions, fields for FB-links L, fields F for attached files and checksums, hashsums, and fields C indicating record closing date, last user and last time for editing. The Project field describes which project the record belongs to, and the record owner field shows which user or actor that owns the record. The number field allows database numbers to match those in handwritten protocols, e.g. a student splitting one cell culture into five new ones is unlikely to label these with the full database ID numbers database ID, table name and record number, but is likely to label them from 1-5 or A-E adding the date and her or his initials. The mark-field enables users to mark records and this information is stored in hidden system tables, see next paragraph. Data tables listing physical materials, like for instance a blood sample, that need to be stored outside the database also have a field for storage location. By keeping this degree of standardization, specialized functions can be made to look for the presence of certain fields in a given table, and then perform specific actions and at the same time there is sufficient flexibility to allow storage of more or less anything.

Hidden system tables are used by the database system itself. For instance, the FB-links, see FIG. 2, may be represented in the system as records in a hidden link table, LT in FIG. 3. This table comprises the complete identity of the record a link comes from and the complete identity of the record it is linked to. This is illustrated in the figure as fields for database license numbers I, table names TN and record numbers #. The link table also comprises fields for link notes LN, and link identification number L# and may comprise other fields as well V. However, FB-link information may be handled in alternative ways. The essence is the use of unique record and database identification numbers.

Another example of hidden system tables, not illustrated in the figure, is the table that stores the information in the “Mark” x field. Users may mark any record with any combination of letters and numbers, a “Mark text”, in order to facilitate selection of records, for instance after searches. Marks are not stored in the regular data tables, but are represented by records in hidden system tables. Each mark record has fields describing the mark text, which regular record this mark belongs to, and which user has added the mark. When a user views a table, the system only shows the marks added by that user, and only that user can delete his own marks.

Temporary data tables (not illustrated in the figure) comprising information that is of temporary interest or needs frequent updating, or information that should be selected or analyzed before a decision can be made if it should be permanently stored. Examples of the latter comprise searches in external databases for bibliography or DNA sequences. Only a tiny bit of the total information retrieved is of any relevance to the researcher. Thus, the researcher must be able to make a selection. An example of the former comprises generation of an updated list of all the items stored at a particular location, for instance a particular laboratory freezer. To do this, it is not sufficient to search one data table, e.g. Sample, because the same storage location may comprise material recorded in other data tables, e.g. Antibody, Chemical, Serum; Bacterial stock. And because the content of the storage location will change, there is no point in storing these searches permanently. If needed, however, these search results can be exported, printed or transferred to a permanent data table.

Database configuration tables (not illustrated in the figure) used by the database administrator, Superuser, to set database policies and control the use of the database. These comprise various tables fine tuning user rights. Strict rules regarding authenticity and record ownership are not always practical. If, for instance, someone has been hired to make an inventory of a storage room or a freezer, and has either not completed the job or completed it with errors, then Superuser can give another user the power to edit the records entered by the first user. This power can be global or restricted to a particular project or data table. Thus, Superuser may not give the new user the power to overwrite all of the records entered by the first user. Superuser decides how long after creation records shall be open for editing. This time interval can be set differently for the different data tables. When the defined time has elapsed, records will close. Only Superuser can open a record for editing after “Closing date”. There are also tables comprising help information including descriptions of how the different tables and the fields in them are supposed to be used. Another configuration table lists permitted FB-links, i.e. the link policy described in FIG. 2, as well as a number of other setup tables, e.g. listing time to record closing dates for each table.

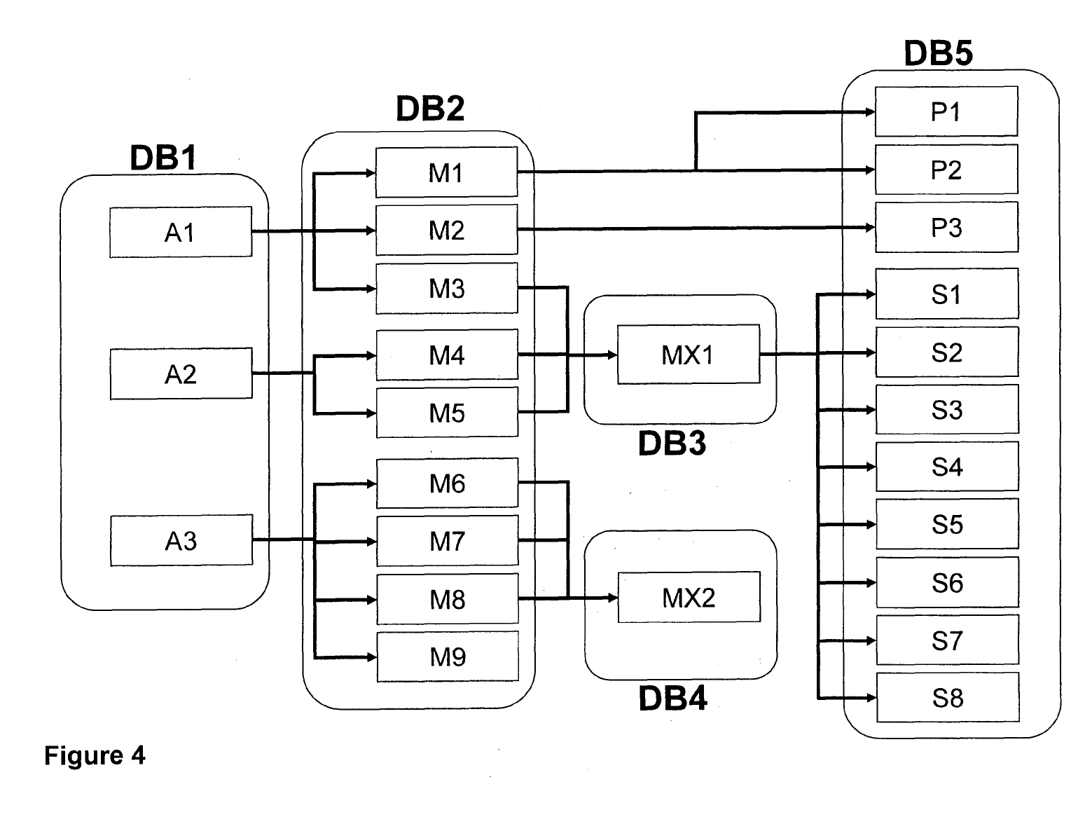

FIG. 4 illustrates how starting material typically gives rise to a number of other materials, resulting in a FB-link-chain with diverging and converging ramifications, a FB link-tree. This is exemplified by food production and the work flow is recorded in several different databases DB1-5 as the materials are shipped from one organization to another. Animals A1-3 are recorded in the database of a farmer DB1 who exports the animals to a slaughter house. Here the animals give rise to several meat products M1-9. Some meat products are shipped to factories DB3-4 and some directly to a shop DB5. One factory mixes meat from several animals together MX1 and produces sausages S1-8. The arrows represent FB-links pointing in forward direction.

The System has an array of different search tools built in, but the types of searches that make the present System special are the searches that go along the FB-link tree in the backward or in the forward direction. The searches can be performed in forward or backwards direction until stop points set by the user. The searches may also be set up to go in one direction to a certain step and then in the other direction. The usefulness of this is illustrated in the following example: if sausages S1-8 are infected, the infection may have occurred at different steps in the production chain. It could be the meat mixture MX1 in the factory or it could be in the slaughter house. If it happened in the slaughter house, then meat package P1-3 may also be infected.

The potential of the described database system stems not only from the flexibility and power described above, but also from the fact that each database has its own administrator, Superuser. This is essential because it implies that level of privacy is locally controlled, and thereby invites the local users to use the system for organizing data they would not like to enter into a system over which they have no control. For instance, a farmer shipping animals to a slaughter house, exports the relevant information on the animals to the database of the slaughter house upon delivery of the animals. Because the farmer controls the export, he or she may safely use the same database to archive data not relevant for the slaughter house, and thereby use the database to manage the general running of the farm in much the same way as a researcher wants to manage a research group. The exact method of data export will depend on e.g. the need for database security. One alternative is online communication between databases. The highest level of security, however, will be achieved by exporting data to a temporary database or as organized text or XML files and the attached files as individual files. The exported files can then be inspected, copied to a transferable storage medium and imported into the other database. Authentication can still be secured by digitally signing exported information, and by exporting associated checksums.

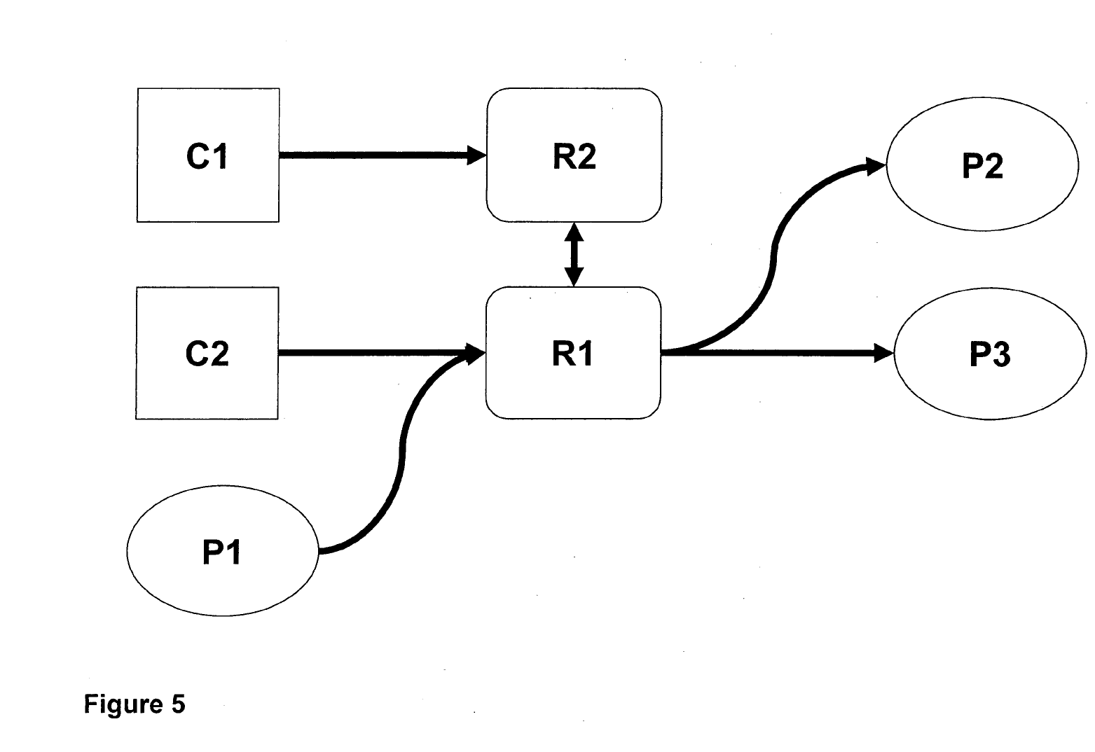

FIG. 5 illustrates how a research group operating database 1 R1 may collect information from public databases P1 and from core facilities C1-2, both directly and via material obtained from a collaborator R2. The Superusers of database 1 and 2 may agree to synchronize part of their databases. This can be done selectively, e.g. for marked data records only, for all records produced by one individual, all records generated within the framework of a single project or the entire database. In addition, when a Superuser decides to do so, selected data may be uploaded to for instance databases operated by scientific journals or other databases P2-3.

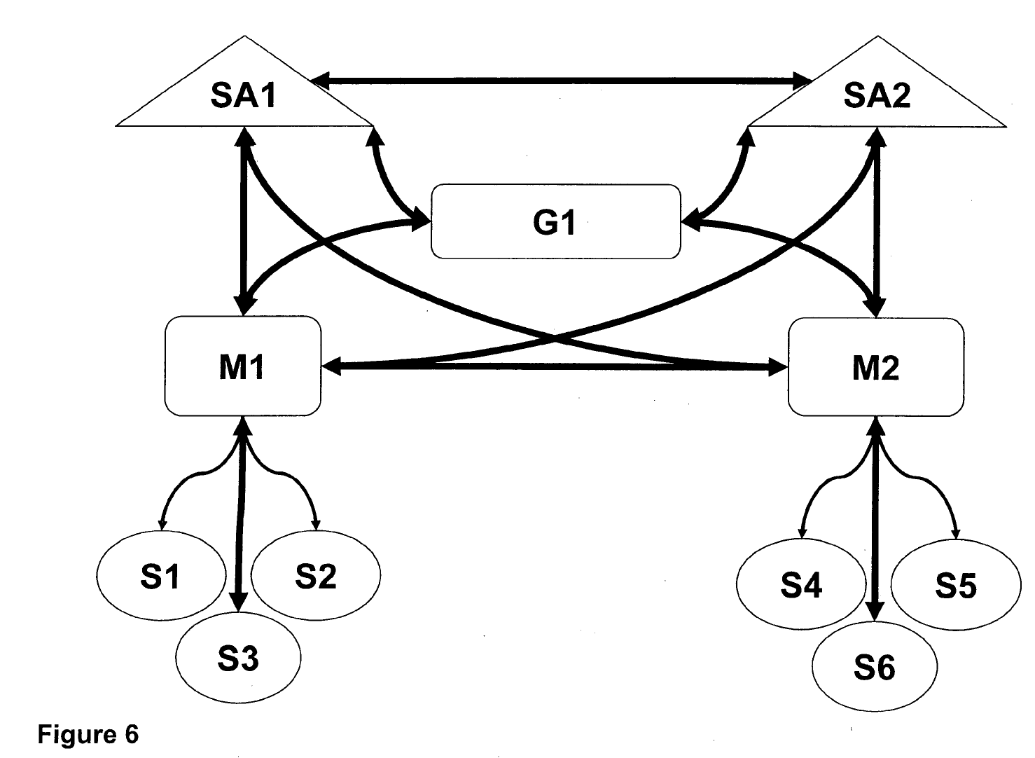

FIG. 6 illustrates how the System represents a unit that can be connected to other units resulting in a distributed system of databases. This figure also shows examples of how different versions of the System may be developed. For instance, there may be made both multi-user and single user versions of the system with different capabilities. A group leader supervising a number of students may prefer the full multiuser system M version. Two of these systems M1 and M2 are indicated. In this version Superuser can create users and set user rights. Superuser can also generate free copies of the software S1-6 so that other group members can use for instance their laptops as satellites to record data off line, and then synchronize their copies with the main database M when needed. The Superuser determines how much and which types of information the individual single user copies are allowed to comprise. The single user copies are satellites of the main system and cannot communicate with each other. A single user satellite may be upgraded to a Single User Stand Alone version SA. This version can communicate with other databases just like the full version, but has only one user with full control, a Superuser. This figure also illustrates that it may be convenient to establish database networks on several levels such as internally within a research group/company, between research groups/companies, and between local databases and governmental organizations. Certain types of information may be uploaded to a database operated by a university IT-department or by a governmental agency G1.

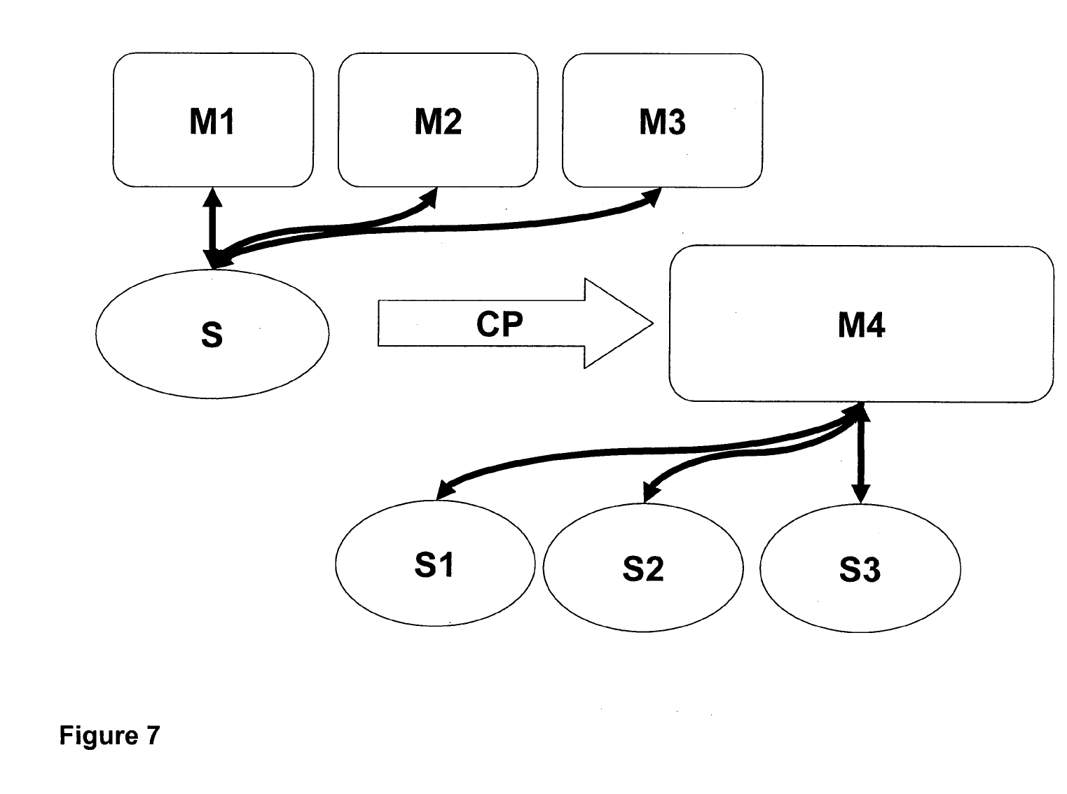

FIG. 7 shows how a user may collect his or her entire career path CP. A student may obtain a free satellite copy S from the group leader, Superuser, running database M1 upon his or her first employment e.g. as master student. Then as the student moves along to new research groups first as a PhD-student and later as a postdoctor, the student becomes connected to the databases operated by the other group leaders. The student collects all his work in his database and synchronizes the relevant information with the relevant group database. At some point the student may become an independent researcher, obtain her or his own research funding and start to recruit his or her own students. The new group leader may upgrade to the full version of the database system M4 and obtain the ability to set user rights and to generate database satellites S1-3 for the new students.

### The System Allows Unlimited Diversity of Data Categories

This is achieved because the System uses generic tools for data storage, data import and entering, data viewing and searching as well as database management.

As mentioned above, new data categories and data formats can easily be stored simply by adding new data tables by using a function available to Superuser. After adding the new table, Superuser decides where the FB-links should go and controls this easily by entering or deleting records in the configuration table comprising the list of permitted FB-links. It is important to note that existing links are not affected by changing the list of permitted links. This only affects the ability of ordinary users to create new ones. Thus, a change in database policy does not make old data unreadable and does not affect search functions.

When importing data from a database comprising tables not existing in the recipient's database, then the data will be imported together with the table definition and the table description, stored in the Help table, which is one of the configuration tables. This implies that the system does not depend on a standardized organization of the data, because it imports the data, the data organization and the links between the data.

Nevertheless, order is an advantage, and the Superuser can choose to submit the table definition he or she has created to a central database managing data table definitions. This will enable the administrator of the central database to monitor the global need for new data formats and thereby to develop new data tables based on the received suggestions. By constantly updating the collection of data tables a rapid development of a world wide standardization of data storage formats is facilitated. The formats supplied by the system developer, however, will only be widely used if they are good. Otherwise the users will create their own. Thus, the development of a standard will be user driven rather than enforced by a top-down approach. The present invention represents both a way to function in the absence of standardization and provide the means to develop standards.

### Viewing Records

Superuser decides which data tables users are allowed to view. The simplest and most basic view is to display the content of tables in a table-like format where lines called rows represent records and fields are shown in columns as illustrated in FIG. 2. To make space to display more of the information of a record at once, individual records may also be displayed in such a way that the fields are presented in larger and scrollable text windows. Sometimes, more complex views, called “workspaces”, are needed because information has to be assembled from more than one data table. These views also allow editing records, and are useful when planning experiments as they resemble the appearance of traditional notebooks. One of these complex views displays a single record, and below it all the records linked in the forward direction. This view is useful when for instance listing all blood samples obtained from one animal, or when listing all the different fractions obtained after a fractionation experiment. Another complex view displays a record and all backwardly linked records. Other views showing multiple linked records can display them horizontally or vertically relative to each other. Even a limited number of different combinations, will cover most visualization needs. The beauty of the system is that these views are generic and will work in all tables. Generic view tools are possible because of the standardization of table structure, FIG. 2, and will work even though Superuser adds new tables. By using a generic view generator, users can fine tune their complex views, or make new ones, according to their needs and preferences.

### Entering and Editing of Records and FB-links

A user can only modify data in records he or she owns and only until the closing date, unless Superuser grants special powers. When a record is created, or when it is updated, the closing date of that record is automatically set to a date a certain number of days in the future. This means that when a record has not been edited for a certain time interval, it will automatically be closed.

User compliance requires powerful entering and editing tools. Simple editing tools are not described here as they resemble those commonly enabled in spreadsheets and other similar programs. The editing tools worth mentioning are tools that enter or edit both records in regular data tables and records in the FB-link table at the same time or sequentially depending on user preferences. For instance, when inserting a copy of another record, then the user will be asked if he or she also wants to copy FB-links backwards, link notes, shared files and FB-links forwards. When for instance photographing an object, a material already recorded in the database, new image records are to be entered. This is done by first retrieving the existing record describing the object to be photographed, and then using the “Input Linked Record” function. This function will first display a dialog box showing the permitted tables to create linked records to in the forwards and backwards directions. After selecting the desired table, the program creates the new records, links them to the selected starting material records in the selected direction, and displays the new records so that the user can continue entering information into them. When linked records are inserted, the current date will be suggested for the Date field, and the contents of the Project field and the Number field of the starting record or records are copied into the new record or records. Other fields will be copied according to a system configuration table. For Superusers the process is the same except that new linked records may be inserted into any table, allowing full flexibility as special cases may arise in research laboratories.

### Entry of Old Data and Incomplete Data Sets

The system allows entry of old data and of incomplete data sets. This is highly useful when reconstructing information from incomplete laboratory notebooks, including when investigating suspected scientific misconduct. Although these records will appear in the link chain according to when the experimental work was done, the system will also record when the records were created and last edited.

### Reorganization of Table Structure

Because data organization, typically in the form of table and link structure, will be subject to development as new needs are discovered, it will from time to time be necessary to reorganize tables. Special editing functions only available to Superusers comprise moving of records between tables, splitting of records, and inserting new records into a FB-link chain. These editing tools do not only handle the records, but also updates both the FB-link table and attached files. The following enables links from other databases to find records if table names change or records move: If a table name is changed, then the old and new table names are logged, and the old name will not be reused by new tables. If a record is moved, then the old and new location, i.e. table and id, of the moved record are logged, and the old id of the moved record will not be reused by new records in the same table. To retrieve a linked record in another database, the database id is used to find the network address of the database from an address server, and the database is asked for the record with table name and id. If the table name does not exist, then the log is checked for a possible table renaming, and if the id does not exist, then the log is checked for a possible new location of the record.

### Generation of Labels

Once records are created and numbered, then the “Print label” function creates labels for all the samples. These labels will comprise the unique database IDs, including in barcode format, and the contents of fields selected by the user and other information as desired.

### Attached Files are Stored in the Database, but can be Opened by External Programs

As described above, any number of files can be attached to an individual record similar to the way files are attached to emails or be shared by several records. The contents of the files are stored as binary objects in hidden tables. The attached files can be retrieved from the database, and after retrieval they are identical to the files originally uploaded. The database can automatically open the retrieved files using external programs, e.g. MS Word for doc-files and Adobe Acrobat for pdf-files, as desired by the user. This approach allows in principle any type of files to be stored. Thus, the huge variety good programs that already exist may be used in conjunction with the present innovation which thereby offers a common framework for storing files from these other programs.

Extremely big files may be stored outside the database. In such a case, the database refers to the storage location of the disks or tapes and provides them with an ID. The integrity and identity of such externally stored files is verified by storing hash-sums of these files in the database.

Programs may be Modified to Read and Write Directly from the Database

E-mail programs may be configured to use tables in the database as mailboxes. This enables linking of e-mail together so that a correspondence can easily be followed backwards in time. Further, it makes it easy to archive all work-related e-mails into one system for easy backup and, just as importantly, makes it easy to link e-mail correspondence to other activity, e.g. shipment of materials, discussions about manuscripts or analysis results.

Further, a number of excellent programs are available for handling bibliographic information, for example Reference Manager from Thompson Scientific. A major drawback, however, with the existing bibliography programs is that these databases typically do not integrate well with the laboratory notebooks, and most of these programs are single user programs making it difficult to organize a research group or company database. These problems can be solved either by modifying the existing programs to use the database in the System or by building this functionality into the System. When doing this, then the same software may not only be used to generate lists of references, but might just as well be used to generate lists from data stored in any table, for instance generate formatted lists of e.g. addresses, antibodies, analysis results and animals.

A consequence of the ability of the System to link all these different data categories and programs together, is that the System becomes a management tool for knowledge as well as for general laboratory management,

### Versatility

The principles of the System described above can be applied to all types of research and research-like activities, including molecular biology, electrophysiology, immunology, stem cell and cancer research as well as behavioral research. For instance, information on physics related to for instance advanced equipment may be imported from databases operated by physicists. Databases operated by farmers may be connected to those operated by chemists and engineers as well as health authorities and oil producers and so on.

The System allows production of novel searching devices for customers who have special needs, e.g. customers who have food allergies, e.g. to shellfish or nuts, or religious or political convictions and therefore want to know if there could be traces of for instance allergens, pork or genetically modified crops in a particular food product on offer in a shop. Access to this level of detail, will enable calculation of the nutritional value of food with a high degree of precision, and also calculation of the exposure to environmental toxins etc.

The system may also be used in a completely different way like for instance form the basis for a new way of organizing multiple choice examination tests making them more similar to oral examinations. Standard multiple choice tests typically comprises a number of questions with multiple alternative answers. The candidates choose one of the answers and move to the next question. This is rigid, but can be done objectively and with little manpower, in contrast to oral examinations where examiner and candidate meet face to face. Oral examinations are both subjective and personnel intensive and subjective, have the advantage of flexibility allowing questions to be asked based on the last answer thereby following a line of argument and allowing the candidate to correct himself or to expose major lack of knowledge. The present system would make it possible to combine the advantages of the multiple choice test with that of the oral examinations in that each alternative answer can be linked to new questions as well as attaching pictures or other files to the questions.

### Authentication

Because the work-flow is broken up into smaller work-units carried out by individual actors, data is recorded and authenticated in practically real time, and records can be completed when entered, minimizing the need for later editing and updating, and it becomes unnecessary to allow actors to alter the records of other actors. Because editing of existing records is the exception rather than the rule, it is feasible to record all changes to the database as well as the people who did them and the time this was done. Because the data entered into the system is authenticated, it will have an extra benefit in countries where patenting is based on first to invent since the inventor can reliably locate patentable notes and verify these in terms of time.

Although editing of closed records is limited, they can be commented by creating new records FB-linked to them.

The policy of giving each database owner administrative Superuser rights can be combined with authentication such as date of first invention, in spite of the fact that the Superuser will have full control of all data, and, in principle, can change all data stored in the database. This can be done in several ways, alone or in combination depending on the need for authentication:

1. By attaching scans of the hardcopies of notes and computer printouts to the database records and then keeping the originals labeled with the database ID-numbers in a traditional archive system. By combining the traditional notebook with the database, falsification is made considerably more difficult.

2. By taking regular backups of the complete system and storing the backup disks permanently. Superuser may store these backups in such a way that they can no longer be tampered with, but even if the Superuser also has physical access to the backups it will be hard to introduce changes in the packed backup files without creating traces or making mistakes e.g. forgetting to change linked information. The database automatically records all changes to all records after “closing date”, and all changes performed by Superuser or those authorized by Superuser of records belonging to other users.

3. By exporting records to databases controlled by others. Once data has been distributed, see FIGS. 4-7, then it will be less attractive to modify the original records. Large organizations or governmental agencies may offer or demand that certain data categories are uploaded to their databases, see FIG. 6).

4. By generating digital checksums and storing these in the database, or subscribing to a service, e.g. provided by the database vendor, whereby the digital checksums produced by the database are deposited in an external database. These checksums may also be exported together with the records.

1. A notebook system for storing traceable information for use within research, industry, food production and the like, comprising
a local database to store necessary/required information in,
means for entering input into the local database,
means for viewing data in the local database,
means for reporting data in the local database,
characterized in
means for establishing a distributed network of independent databases that are locally controlled,
means for enabling export and import of data from databases within the network or other external databases,
each record in the distributed network of independent databases have unique identifiers,
means for enabling any record to be linked to any other record within the local database or to one of the other independent databases in the distributed network,
means for enabling import of data from other type of electronic equipment with their own systems,
means for authenticating data input,
means for importing data wherein new data is transformable into a new format using new database tables and said database system creates an appropriately formed table for importing the data into.

2. Notebook system according to claim 1, wherein each independent database is operable to evolve on its own.

3. Notebook system according to claim 1, further comprising means for communicating with instruments.

4. Notebook system according to claim 1, further comprising means for communicating with other databases using encrypted communications.

5. Notebook system according to claim 1, wherein there exist system tools for upgrading the database system from a limited system to a full working system.

6. Notebook system according to claim 1, wherein each user input is authenticated and date and time stamped.

7. Notebook system according to claim 1, wherein each record is operable to be given a time stamp.

8. Notebook system according to claim 1, wherein the system is operable to search forward and backward from any record in the database and thus generate a FB link-tree.

9. Notebook system according to claim 1, wherein the users' permissions to create links between data records are restricted by a database link policy.
